(19) United States
(12) Patent Application Publication
(10) Pub. No.: US 2006/0162674 A1
(43) Pub. Date: Jul. 27, 2006

(54) Illuminated dog leash

(76) Inventor: Gabe Neiser, Port Jefferson Station, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 10/637,196

(22) Filed: Aug. 8, 2003

(51) Int. Cl. A01K 27/00

(52) U.S. Cl. 119/795

(57) ABSTRACT

There is provided an illuminated dog leash. The illuminated dog leash includes a leash portion having a reflective material, a handle portion, and a light source connected to the handle portion for illuminating at least the reflective material of the leash portion.

### FIELD OF THE INVENTION

The present invention generally relates to dog leashes and, more particularly, to an illuminated dog leash.

### BACKGROUND OF THE INVENTION

Dog walking can pose a risk to the dog being walked as well as to the person walking the dog. For example, walking a dog along a curb leaves the dog and the walker susceptible to being struck by a vehicle, particularly when no means are used to indicate the position of the dog and/or the walker with respect to oncoming traffic.

As such, various types of approaches have been implemented to make dog walking safer. One such approach is the use of an illuminated animal collar as described in U.S. Pat. No. 6,055,942, issued on May 2, 2000, the disclosure of which is incorporated by reference herein. The illuminated animal collar renders a dog more visible in the absence of ambient light. However, the illuminated animal collar does little if anything to illuminate the dog walker, who may be several feet away from the dog and, thus, susceptible to being struck by a vehicle even if the dog is not.

Another approach to making dog walking safer is the use of an illuminated pet leash as described in U.S. Pat. No. 5,967,095, issued on Oct. 19, 1999, the disclosure of which is incorporated by reference herein. The illuminated pet leash includes a light source incorporated therein, thus repair and/or replacement of the light source is rendered more complicated by the intermingling with the leash itself.

Accordingly, it would be desirable and highly advantageous to have an illuminated dog leash that overcomes the above-described problems of the prior art.

### SUMMARY OF THE INVENTION

The problems stated above, as well as other related problems of the prior art, are solved by the present invention, an illuminated dog leash.

According to an aspect of the present invention, there is provided an illuminated dog leash. The illuminated dog leash includes a leash portion having a reflective material, a handle portion, and a light source connected to the handle portion for illuminating at least the reflective material of the leash portion.

According to another aspect of the present invention, the illuminated dog leash further includes a mount connected to the handle portion and the leash portion for allowing the leash portion to pivot with respect to the handle portion.

According to yet another aspect of the present invention, the mount includes a re-enforced ball joint system.

According to still yet another aspect of the present invention, the mount includes a frontal portion that is clear and/or translucent. The light source is disposed within the mount behind the frontal portion to provide illumination through the frontal portion while providing impact protection to the light source.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating an illuminated dog leash 10, according to an illustrative embodiment of the present invention;

FIG. 2 is a diagram further illustrating the illuminated dog leash 10 of FIG. 1, according to an illustrative embodiment of the present invention; and

FIG. 3 is a diagram illustrating an illuminated dog leash 30, according to another illustrative embodiment of the present invention.

### DETAILED DESCRIPTION OF THE INVENTION

The present invention is directed to an illuminated dog leash. Advantageously, the illuminated dog leash according to the present invention includes at least one light source for illuminating the leash so as to provide a highly visible link between the dog and the dog walker. As such, the location of the dog and the walker may be ascertained by passersby (e.g., motorists), thereby reducing a risk posed to the dog and walker had their locations not been known.

Moreover, the illuminated dog leash according to the present invention separates the light source from the leash so as to simplify the repair and/or replacement of the light source and/or leash in contrast to the prior art. Further, the illuminated dog leash according to the present invention may advantageously be used to not only illuminate the leash itself but to also provide light for navigational use by the dog walker as well as to illuminate, for example, the walker, the dog, and/or a region proximate to the dog and/or walker. Also, the illuminated dog leash according to the present invention may advantageously be implemented in a rechargeable form so as to dispense with the need to purchase new batteries, thereby minimizing the cost of usage. These and other attendant advantages of the present invention will become apparent to one of ordinary skill in the related art in light of the description of the present invention and drawings corresponding thereto.

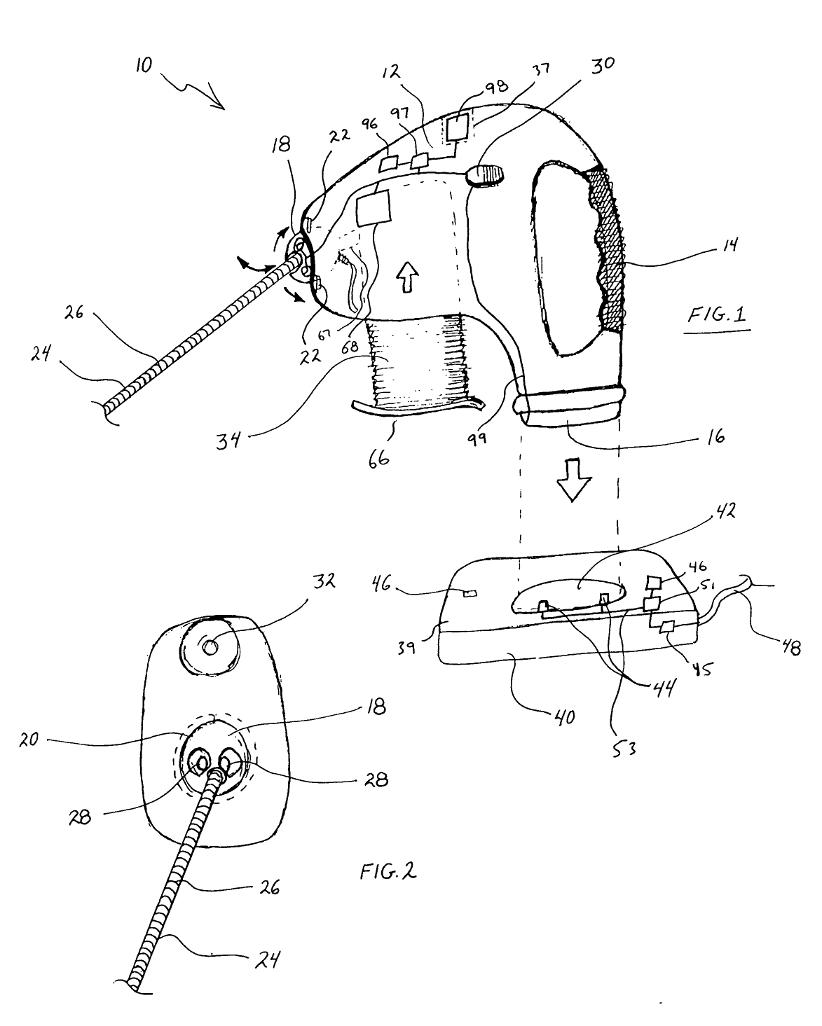

FIG. 1 is a diagram illustrating an illuminated dog leash 10, according to an illustrative embodiment of the present invention. FIG. 2 is a diagram further illustrating the illuminated dog leash 10 of FIG. 1, according to an illustrative embodiment of the present invention.

The illuminated dog leash 10 includes: a housing 12 having a handle portion 14; a pivoting mount 20; a light source 28 disposed on the pivoting mount 20; a power switch 30 for the light source; retention devices 22; a leash portion 24 that includes a reflective material 26; a retractable leash organizer/holder 34 for the leash portion 24; a conductive circuit 99 having a conductive ring 16; a built-in flashlight 32 having its own power switch (not shown); a rechargeable battery 98; a charge evaluation circuit 97; a charge indicator 96, and a retraction device 68. It is to be appreciated that the present invention is not limited to the specifics shown and described with respect to FIG. 1 and, thus, other variations thereof and modifications thereto may be implemented by one of ordinary skill in the related art while maintaining the spirit and scope of the present invention.

In the illustrative embodiment of FIG. 1, the pivoting mount 20 includes a re-enforced ball joint system with the leash portion 24 anchored thereto, and with light sources 28 integrated into the frontal portion 18 of pivoting mount 20. However, it is to be appreciated that the present invention is not limited to the specifics of the embodiment of FIG. 1 and, thus, other types of mounts and other positions for the light source 28 on the mount 20 may also be employed while maintaining the spirit and scope of the present invention. As one example, the light source 28 may be disposed at a location other than on or in the pivoting mount 20. Such other location may include, for example, a location on or in the leash portion 24.

The retention devices 22 retain the pivoting mount 20 in the housing 12 but may be readily disengaged to facilitate service and/or removal of the pivoting mount 20 from the housing 12. In the illustrative embodiment of FIG. 1, the retention devices 22 are shown as clips. However, one of ordinary skill in the related art will contemplate these and various other implementations of retention devices for retaining the mount 20 in the housing 12 and for permitting removal of the mount 20 from the housing 12 while maintaining the spirit and scope of the present invention. Moreover, some embodiments of the present invention may even use permanent retention devices that simply retain the mount 20 in the housing without permitting removal of the mount 20 from the housing 12.

The handle portion 14 of the housing 12 may optionally include finger grips or other ergonomic forms or arrangements for facilitating gripping of the housing 12 by a user and may further include a rubberized or other non-slip surface thereon for providing a more positive grip. Preferably, the handle portion 14, as well as other portions of the illuminated dog leash that are exposed to the elements, are made of a weather resistant material(s). For example, the handle portion 14 may be made of plastic or other durable material, the leash portion 24 of nylon, and so forth.

The leash portion 24 is preferably, although not necessarily, round in shape and of a material having high-strength, particularly high tensile strength. As an example, the leash portion 26 could include nylon as noted above or some other suitable high-strength material that is preferably weather resistant.

The reflective material 26 of the leash portion 24 may be implemented, for example, using a fiber optic strand. Of course, other reflective materials and technologies may also be employed to illuminate the leash portion 24 while maintaining the spirit and scope of the present invention. As used herein, the term “reflective” as used with respect to reflective material 26 includes any materials that, for example, reflect light and/or guide light.

The reflective material 26 is illuminated by the light source 28 that is disposed on the pivoting mount 20. In the illustrative embodiment of FIG. 1, the light source 28 consists of two separate light sources. However, it is to be appreciated that one or more than one light source may be employed as light source 28.

While the light source 28 is shown and described with respect to FIG. 1 as being non-directional (e.g., conventional light bulbs without any reflective technology used in conjunction therewith), in some embodiments of the present invention the light source 28 may be a directional light source such that emitted light is directed towards the leash portion 24 to maximize a reflectivity of reflective material 26 included in the leash portion 24. In such a case, the directional light source (more generally the housing 14 itself that contains the directional light source) is maintained in a particular posture with respect to the item(s) to be illuminated. Maintaining such a posture is readily obtained when the pivoting mount 20 is used to locate the light source 28, since movement of the pivoting mount and, hence, the light source 28, is in accordance with the movement of the leash portion 24. Such illumination may optionally be supplemented by built-in flashlight 32. As used herein, the phrase “directed light” and variations thereof refer to light that is directed to a particular and desired direction(s) for example, using reflectors or other technologies that can impact and direct the illumination provided by a light source.

As noted above, built-in flashlight 32 may be used to further supplement any illumination provided by the light source 28.

Further, in some embodiments of the present invention, at least the frontal portion 18 of the pivoting mount 20 may be clear or translucent so that the light source 28 may be positioned within the pivoting mount 20, behind the clear or translucent frontal portion, to provide illumination to at least the reflective material 26 while providing impact protection to the light source 28. Moreover, such an arrangement protects the user from directly contacting the light source 28, which may become hot to the touch during use.

A retraction device 68 (e.g., a motor, a coil or spring, and so forth) may be used to automatically retract the leash portion 24 within the retractable leash organizer/holder 34 when the leash portion is not in use. The leash portion 24 may be retracted through an opening in the pivoting mount 20, through a channel 67 in the housing, and into the leash organizer/holder 34. Alternatively, the leash portion may be placed with the leash organizer/holder from the opening 66. The retraction device 68 is powered by the conductive circuit 99 and is controlled by a separate power switch (not shown). In other embodiments, the retraction device 68 may be powered by a separate dedicated circuit and may be controlled by an event/condition or through a device other than a power switch.

The rechargeable battery 98 is at least partially disposed within the housing 12 via battery receptacle 37. Preferably, the rechargeable battery 98 is fully disposed within the housing so as to protect the rechargeable battery 98 from the elements. Moreover, the rechargeable battery 98 may be removable to facilitate repair and/or replacement of the same, or may be permanently included within housing 12. Contacts (not shown) or other suitable means may be disposed in or near the battery receptacle for use in connecting the rechargeable battery to the conductive circuit 99 (in this example, but not necessarily in other embodiments, through the charge evaluation circuit 97).

The charge evaluation circuit 97 determines the amount of charge remaining on the rechargeable battery 98 while the rechargeable battery 97 is within the housing 12. The charge indicator 96 indicates to the user the charge status of the rechargeable battery, in response to a signal from the charge evaluation circuit 97. The charge indicator 96 may be any type of indicator that at least accomplishes the preceding purpose. For example, a Light Emitting Diode (LED) may be used such that the blink rate or the brightness of the LED is dependent upon the remaining charge, if any, of the rechargeable battery 98. As another example involving LEDs, a plurality of LEDs may be employed in bar graph fashion. At least the charge evaluation circuit 97, the charge indicator 96, the rechargeable battery 98 (when disposed within said housing 12), the switch 30, and/or the conductive ring 16 are all interconnected via the conductive circuit 99.

The illuminated dog leash 10 may be charged using a battery-charging unit 40. The battery-charging unit 40 includes: a housing 39, an aperture 42; contacts 44; a power switch 45; a charge evaluation circuit 51; a charge indicator 46; a conductive circuit 53; and a power cord 48.

The aperture 42 is for receiving and securing the housing 12 during charging of the rechargeable battery 98. In the illustrative embodiment of FIG. 1, the housing 12 is secured by the aperture due to a pressure fit arrangement with the conductive ring 16 or an area above the conductive ring 16.

The contacts 44 are for making electrical contact with the rechargeable battery 98 through the conductive ring 16 and the conductive circuit 99 disposed within the housing 12, when the conductive ring 16 is placed within the aperture 42 so as to physically contact the contacts 44. The power switch 45 is for activating/deactivating the battery-charging unit 40.

The charge evaluation circuit 51 determines the amount of charge remaining on the rechargeable battery 98, when the rechargeable battery 98 is within the battery-charging unit 40 and, thus, controls the charging of the rechargeable battery 98 by providing power to the rechargeable battery 98 when the rechargeable battery is not fully charged and by ceasing to provide power to the rechargeable battery 98 when the rechargeable battery 98 is fully charged. The charge indicator 46 indicates the charge status of the rechargeable battery 98, in response to a signal from the charge evaluation circuit 51. The charge indicator 46 may be implemented as, e.g., a Light Emitting Diode (LED). Accordingly, as an example, blinking of the LED charge indicator 46 may be used to indicate that the illuminated dog leash 10 is still charging while non-blinking of the LED charge indicator 46 may be used to indicate that the illuminated dog leash 10 has completed charging.

The power cord 48 is for receiving power and providing the same to the conductive circuit 53 disposed within the battery-charging unit 40 that provides power to the contacts 44. At least the contacts 44, the charge evaluation circuit 51, the charge indicator 46, the rechargeable battery 98 (when disposed within said housing 39), the power switch 45, and/or the power cord 48 are all interconnected via the conductive circuit 53.

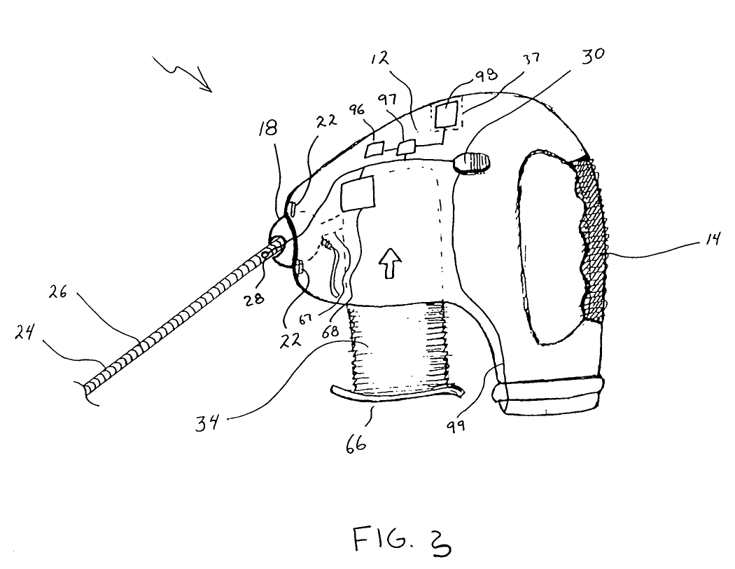

FIG. 3 is a diagram illustrating an illuminated dog leash 30, according to another illustrative embodiment of the present invention.

The illuminated dog leash 30 includes: a housing 12 having a handle portion 14; a pivoting mount 20; a light source 28 disposed on the pivoting mount 20; a power switch 30 for the light source; retention devices 22; a leash portion 24 that includes a reflective material 26; a retractable leash organizer/holder 34 for the leash portion 24; a conductive circuit 99 having a conductive ring 16; a built-in flashlight 32 having its own power switch (not shown); a rechargeable battery 98; a charge evaluation circuit 97; a charge indicator 96, and a retraction device 68. It is to be appreciated that the present invention is not limited to the specifics shown and described with respect to FIG. 1 and, thus, other variations thereof and modifications thereto may be implemented by one of ordinary skill in the related art while maintaining the spirit and scope of the present invention.

The primary difference between the illuminated dog leash 30 of FIG. 3 and the illuminated dog leash 10 of FIG. 1 is the location of the light source 28. In FIG. 1 the light source 28 is disposed on the pivoting mount 20, while in FIG. 3 the light source is disposed on the leash portion 24. It is to be appreciated that the light source 28 may disposed on, in, partially on or in, along the length or a portion of the length of the leash portion 24 or any combination thereof or other related combination or variation as readily determined by one of ordinary skill in the related art while maintaining the spirit and scope of the present invention. It is to be further appreciated that while light source 28 is shown as a single light source in FIG. 3, one or more than one light source may be employed as light source 28 and disposed on the leash portion 24. In any event, the light sources 28 shown in FIGS. 1 and 3 are both for illuminating the reflective material 26 on the leash portion 24.

Advantageously, the illuminated dog leash according to the present invention includes at least one light source for illuminating the leash so as to provide a highly visible link between the dog and the dog walker. As such, the location of the dog and the walker may be ascertained by passersby (e.g., motorists), thereby reducing a risk posed to the dog and walker had their locations not been known.

Moreover, the illuminated dog leash according to the present invention separates the light source from the leash so as to simplify the repair and/or replacement of the light source and/or leash in contrast to the prior art. Further, the illuminated dog leash according to the present invention may advantageously be used to not only illuminate the leash itself but to also provide light for navigational use by the dog walker as well as to illuminate, for example, the walker, the dog, and/or a region proximate to the dog and/or walker. Also, the illuminated dog leash according to the present invention may advantageously be implemented in a rechargeable form so as to dispense with the need to purchase new batteries, thereby minimizing the cost of usage. Other attendant advantages of the present invention are readily apparent to one of ordinary skill in the related art, given the teachings of the present invention provided herein.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An illuminated dog leash, comprising:
a leash portion having a reflective material
a handle portion; and
a light source connected to said handle portion for illuminating at least the reflective material of said leash portion.

2. The illuminated dog leash according to claim 1, further comprising a pivot point connected to said handle portion and said leash portion for allowing said leash portion to pivot with respect to said handle portion

3. The illuminated dog leash according to claim 2, further comprising at least one retention device for retaining said pivot point in said handle portion and for permitting removal of said pivot point from said handle portion.

4. The illuminated dog leash according to claim 2, wherein said pivot point comprises a re-enforced ball joint system.

5. The illuminated dog leash according to claim 2, further comprising a mount that, in turn, comprises the pivot point, and wherein said mount comprises a frontal portion that is one of clear and translucent, and said light source is disposed within said mount behind the frontal portion to provide illumination through the frontal portion while providing impact protection to said light source.

6. The illuminated dog leash according to claim 1, further comprising a rechargeable battery, disposed within said handle portion, for providing power to at least said light source.

7. The illuminated dog leash according to claim 1, wherein said handle portion further comprises a conductive circuit connected to said light source, the conductive circuit for mating with at least one of rechargeable battery and a battery charger.

8. The illuminated dog leash according to claim 1, further comprising a flashlight, disposed at least partially within said handle portion, for providing illumination at least one of in addition to and in place of said light source.

9. The illuminated dog leash according to claim 1, wherein said light source is a directional light source oriented towards at least the reflective material of said leash portion to maximize a reflectivity thereof.

10. The illuminated dog leash according to claim 1, wherein the reflective material comprises at least one fiber optic strand.

11. The illuminated dog leash according to claim 1, wherein said light source comprises at least two separate light sources.

12. The illuminated dog leash according to claim 1, further comprising an indicator for indicating a charge status of a rechargeable battery disposed within said handle portion and electrically connected to at least said light source.

13. The illuminated dog leash according to claim 1, further comprising a retractable leash organizer for storing said leash portion therein when said leash portion is not in use.

14. The illuminated dog leash according to claim 13, further comprising a retraction device for retracting said leash portion through said handle portion and into said retractable leash organizer when said leash portion is not in use.

15. The illuminated dog leash according to claim 1, further comprising a retraction device for retracting said leash portion within said handle portion when said leash portion is not in use.

16. The illuminated dog leash according to claim 1, wherein the handle portion comprises finger grips.

17. The illuminated dog leash according to claim 1, wherein the handle portion comprises an ergonomic portion for gripping by a user.

18. The illuminated dog leash according to claim 1, wherein the handle portion comprises a non-slip portion for gripping by a user.

19. The illuminated dog leash according to claim 1, wherein said leash portion comprises nylon and the reflective material comprises at least one fiber optic strand.

20. An illuminated dog leash, comprising:
a leash portion having a reflective material
a handle portion; and
a light source disposed one of at least partially on and in said leash portion for illuminating at least the reflective material of said leash portion.

21. The illuminated dog leash according to claim 20, further comprising a pivot point connected to said handle portion and said leash portion for allowing said leash portion to pivot with respect to said handle portion

22. The illuminated dog leash according to claim 21, further comprising at least one retention device for retaining said pivot point in said handle portion and for permitting removal of said pivot point from said handle portion.

23. The illuminated dog leash according to claim 21, wherein said pivot point comprises a re-enforced ball joint system.

24. The illuminated dog leash according to claim 20, further comprising a rechargeable battery, disposed within said handle portion, for providing power to at least said light source.

25. The illuminated dog leash according to claim 20, wherein said handle portion further comprises a conductive circuit connected to said light source, the conductive circuit for mating with at least one of rechargeable battery and a battery charger.

26. The illuminated dog leash according to claim 20, further comprising a flashlight, disposed at least partially within said handle portion, for providing illumination at least one of in addition to and in place of said light source.

27. The illuminated dog leash according to claim 20, wherein said light source is a directional light source oriented towards at least the reflective material of said leash portion to maximize a reflectivity thereof.

28. The illuminated dog leash according to claim 20, wherein the reflective material comprises at least one fiber optic strand.

29. The illuminated dog leash according to claim 20, wherein said light source comprises at least two separate light sources.

30. The illuminated dog leash according to claim 20, further comprising an indicator for indicating a charge status of a rechargeable battery disposed within said handle portion and electrically connected to at least said light source.

31. The illuminated dog leash according to claim 20, further comprising a retractable leash organizer for storing said leash portion therein when said leash portion is not in use.

32. The illuminated dog leash according to claim 13, further comprising a retraction device for retracting said leash portion through said handle portion and into said retractable leash organizer when said leash portion is not in use.

33. The illuminated dog leash according to claim 32, further comprising a retraction device for retracting said leash portion within said handle portion when said leash portion is not in use.

34. The illuminated dog leash according to claim 20, wherein the handle portion comprises finger grips.

35. The illuminated dog leash according to claim 20, wherein the handle portion comprises an ergonomic portion for gripping by a user.

36. The illuminated dog leash according to claim 20, wherein the handle portion comprises a non-slip portion for gripping by a user.

37. The illuminated dog leash according to claim 20, wherein said leash portion comprises nylon and the reflective material comprises at least one fiber optic strand.

38. The illuminated dog leash according to claim 20, wherein said light source is disposed at least partially along a length of said leash portion.
